(19) United States
(12) Patent Application Publication
(10) Pub. No.: US 2021/0323378 A1
(43) Pub. Date: Oct. 21, 2021

(54) HEAT MANAGEMENT SYSTEM

(71) Applicants: NOK CORPORATION, Tokyo (JP); NOK KLUEBER CO., LTD., Tokyo (JP)

(72) Inventors: Atsushi KAJIYA, Kanagawa (JP); Kenji MINOSHIMA, Kanagawa (JP); Shoichi MAMIYA, Kanagawa (JP); Shinji ONISHI, Kanagawa (JP); Noriyuki OGAWA, Okayama (JP); Nobuaki YANAGISAWA, Ibaraki (JP)

(73) Assignees: NOK CORPORATION, Tokyo (JP); NOK KLUEBER CO., LTD., Tokyo (JP)

(21) Appl. No.: 17/271,378

(22) PCT Filed: Nov. 12, 2019
(86) PCT No.: PCT/JP2019/044218

§ 371 Date: Feb. 25, 2021

(30) Foreign Application Priority Data
Nov. 13, 2018 (JP) 2018-213272

(51) Int. Cl. B60H 1/00; F28D 20/00

(52) U.S. Cl. CPC B60H 1/00921; B60H 1/00392; B60H 2001/00128; B60H 2001/00949; F28D 2020/006; F28D 20/00

(57) ABSTRACT

A heat management system includes an outdoor heat exchanger that exchanges heat between a heat medium and outdoor air, a compressor that compresses the heat medium heat-exchanged by the outdoor heat exchanger, an indoor heat exchanger that exchanges heat between the heat medium compressed by the compressor and the indoor air, and an external device heat exchanger provided between the outdoor heat exchanger and the compressor, that exchanges heat between the heat generated by an external device and the heat medium.

### TECHNICAL FIELD

The present invention relates to a heat management system.

### BACKGROUND ART

In recent years, air conditioners provided with a heat pump type refrigeration circuit (hereinafter also referred to as “heat pump type air conditioner”)are used as air conditioners for vehicles, for example. A heat pump type air conditioner exchanges heat between outside air in a room, which is an air-conditioning target and a heat medium (coolant) and thereby obtains heat necessary for air conditioning from the outside air. Compared to a case using an electric heater that heats air using electric power, for example, using a PTC (positive temperature coefficient) heater, the heat pump type air conditioner can suppress energy used for air conditioning, during heating in particular (e.g., see Patent Literatures 1 to 3).

### DOCUMENT LIST

### Patent Literatures

Patent Literature 1: Japanese Patent Application Publication No. H9-156351

### Patent Literature 2: Japanese Patent Application Publication No. 2011-152808

### Patent Literature 3: Japanese Patent Application Publication No. 2013-195002

### SUMMARY OF INVENTION

### Technical Problem

The above-described heat pump type air conditioner does not require any heat source to heat air. Thus, the heat pump type air conditioner is useful as an air conditioner used for a vehicle without any internal combustion engine available as a heat source during heating such as an electric vehicle or a fuel cell powered vehicle or a vehicle in which an internal combustion engine is not always in operation such as a hybrid vehicle or a plug-in hybrid vehicle.

However, the heat pump type air conditioner uses heat from air as a heat source during heating as the principle. For this reason, the conventional heat pump type air conditioner involves a problem of being difficult to raise a temperature inside a room sufficiently when there is a little or no temperature difference between a heat medium temperature and an outside air temperature like in cold weather.

To solve the problem of temperature rise in such a heat pump type air conditioner in cold weather, measures combining the heat pump with an electric heater such as the aforementioned PTC heater or measures using a gas injection type heat pump are known.

However, when the electric heater is combined with the heat pump type air conditioner, the electric heater consumes power, and so energy consumption during heating increases. Especially when the electric heater and the heat pump are combined to be used as an air conditioner for an electric vehicle, the electric heater consumes a traveling battery mounted on the vehicle, resulting in a problem of cruising distance being reduced. In an environment in which an outside air temperature falls below a minimum temperature of a heat medium, for example, in an extremely cold region, even an air conditioner using a gas injection type heat pump has difficulty raising the temperature in the room sufficiently.

The present invention has been implemented in view of the above problems, and it is an object of the present invention to provide a heat management system capable of reducing energy consumption and improving heating performance.

### Solution to Problem

In order to attain the above-described object, a heat management system according to the present invention is a heat management system that performs heat management in a room, including an outdoor heat exchanger that exchanges heat between a heat medium and outdoor air, a compressor that compresses the heat medium heat-exchanged by the outdoor heat exchanger, an indoor heat exchanger that exchanges heat between the heat medium compressed by the compressor and the indoor air, and an external device heat exchanger provided between the outdoor heat exchanger and the compressor, that exchanges heat between the heat generated by the external device and the heat medium.

In the heat management system according to one aspect of the present invention, the outdoor heat exchanger receives heat from the outdoor air and radiates the heat to the heat medium, the external device heat exchanger receives heat from the external device and radiates the heat to the heat medium, the compressor compresses and heats the heat medium, the heat of which is received from the outdoor heat exchanger and the external device heat exchanger, and the indoor heat exchanger heats the indoor air with the heat medium heated by the compressor.

In the heat management system according to the one aspect of the present invention, the external device heat exchanger stores heat generated by the external device and exchanges heat with the heat medium.

In the heat management system according to the one aspect of the present invention, the external device heat exchanger is provided with a heat radiation unit that radiates heat generated by the external device, a heat storage unit that stores heat radiated by the heat radiation unit and a heat reception unit that causes the heat medium to receive the heat stored in the heat storage unit.

In the heat management system according to the one aspect of the present invention, the external device heat exchanger is provided with an electric heating unit that heats the heat storage unit.

### Effects of Invention

According to the present invention, it is possible to reduce energy consumption and improve heating performance.

### BRIEF DESCRIPTION OF DRAWINGS

FIG. 1 A functional block diagram illustrating a schematic configuration of a heat management system according to a first embodiment of the present invention.

FIG. 2 A schematic view illustrating a schematic configuration of an external device heat exchanger provided for the heat management system shown in FIG. 1.

FIG. 3 A cross-sectional view illustrating a schematic configuration of the external device heat exchanger provided for the heat management system shown in FIG. 1.

FIG. 4 A functional block diagram illustrating a schematic configuration of a heat management system according to a second embodiment of the present invention.

FIG. 5 A flowchart illustrating operation of the heat management system according to the second embodiment.

FIG. 6 A functional block diagram illustrating operation immediately after heating operation starts in the heat management system according to the second embodiment.

FIG. 7 A functional block diagram illustrating operation of heat exchange by an external device heat exchanger in the heat management system according to the second embodiment.

FIG. 8 A functional block diagram illustrating operation of heat exchange by the external device heat exchanger and the cooling heat exchanger in the heat management system according to the second embodiment.

FIG. 9 A functional block diagram illustrating operation during cooling operation in the heat management system according to the second embodiment.

FIG. 10 A flowchart illustrating operation during charging of the storage battery in the heat management system according to the second embodiment.

FIG. 11 A functional block diagram illustrating a schematic configuration of a heat management system according to a third embodiment of the present invention.

### DESCRIPTION OF EMBODIMENTS

Hereinafter, heat management systems according to embodiments of the present invention will be described with reference to the accompanying drawings. The heat management system performs indoor heat management in a vehicle, a building or the like. In the following description, the heat management system will be described by taking as an example, an air conditioner mounted on an electric vehicle to perform air conditioning in a vehicle room of the electric vehicle as a predetermined space to be a heat management target.

### First Embodiment

First, a heat management system according to a first embodiment of the present invention will be described.

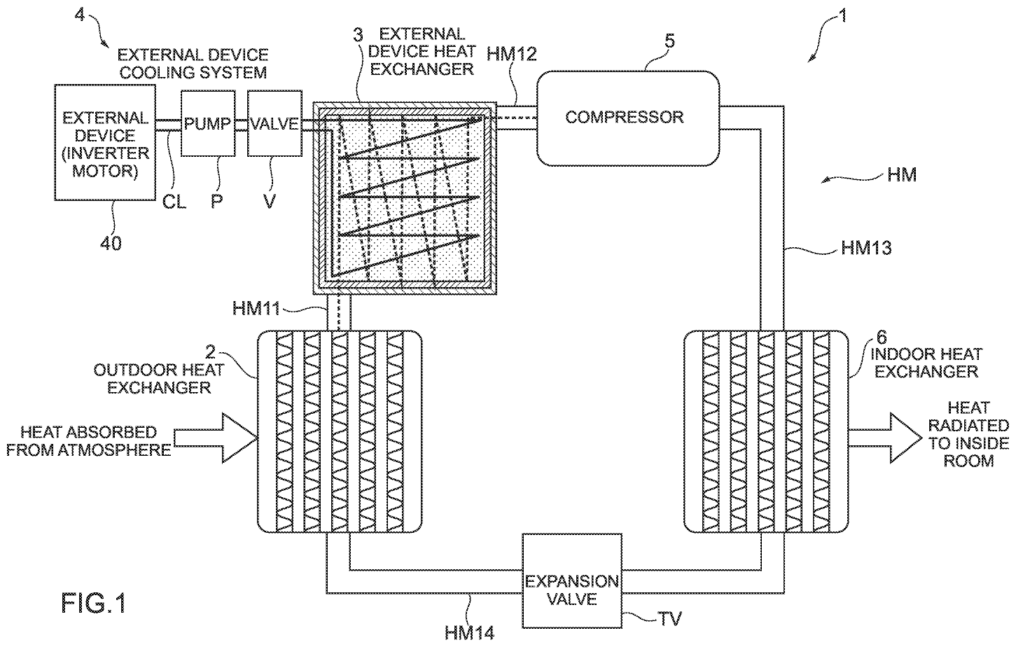

FIG. 1 is a functional block diagram illustrating a schematic configuration of a heat management system 1 according to the first embodiment of the present invention. In the first embodiment, the heat management system 1 is presented to describe a basic configuration of the heat management system according to the present invention. The heat management system 1 in the present embodiment is an example of a heat pump type heating system that uses air heat outside the room as a heat source to increase a temperature in the vehicle room.

As shown in FIG. 1, the heat management system 1 according to the present embodiment is provided with an outdoor heat exchanger 2 that exchanges heat between a heat medium and outdoor air, a compressor 5 that compresses the heat medium heat-exchanged by the outdoor heat exchanger 2, an indoor heat exchanger 6 that exchanges heat between the heat medium compressed by the compressor 5 and indoor air, an external device heat exchanger 3 that exchanges heat between the heat generated by an external device 40 provided between the outdoor heat exchanger 2 and the compressor 5, and the heat medium. Hereinafter, a structure and operation of the heat management system 1 will be described more specifically.

A heat medium circuit HM that can circulate a heat medium is formed between the outdoor heat exchanger 2, the external device heat exchanger 3, the compressor 5, and the indoor heat exchanger 6 in the heat management system 1. For the heat medium, a medium similar to one generally called “coolant” used for an ordinary air conditioner can be used. The heat medium circuit HM is constructed of flow paths HM 11 to HM 14. The flow path HM 11 connects between the outdoor heat exchanger 2 and the external device heat exchanger 3. The flow path HM 12 connects between the external device heat exchanger 3 and the compressor 5. The flow path HM 13 connects between the compressor 5 and the indoor heat exchanger 6. The flow path HM 14 connects between the indoor heat exchanger 6 and the outdoor heat exchanger 2. In the heat management system 1, the outdoor heat exchanger 2, the external device heat exchanger 3, the compressor 5, and the indoor heat exchanger 6 are connected in order via the heat medium circuit HM to thereby form a heat pump type refrigeration circuit.

Examples of the external device 40 include various heat sources such as a power motor of an electric vehicle, an inverter used to control a motor, and provided outside the heat management system 1. A cooling liquid such as LLC (long life coolant) for cooling a motor or an inverter provided between the external device heat exchanger 3 and the external device 40 or for cooling the external device 40 like a traveling battery is generally used to cool a motor or inverter of an electric vehicle. Thus, the external device 40 is built in the external device cooling system 4. The external device cooling system 4 is provided with a cooling liquid circuit CL that can circulate a cooling liquid, a pump P for circulating the cooling liquid between the external device 40 and the external device heat exchanger 3 and a valve V for controlling a flow rate of the cooling liquid between the external device 40 and the external device heat exchanger 3.

A heat medium expanded by an expansion valve TV flows into the outdoor heat exchanger 2 and the outdoor heat exchanger 2 exchanges heat between the heat medium and outdoor air. The outdoor heat exchanger 2 in the heat management system 1 more specifically functions as an evaporator that absorbs heat from the outdoor air to the heat medium.

As shown in FIG. 1, the external device heat exchanger 3 is provided in the flow path HM 12 between the outdoor heat exchanger 2 and the indoor heat exchanger 6 of the heat medium circuit HM.

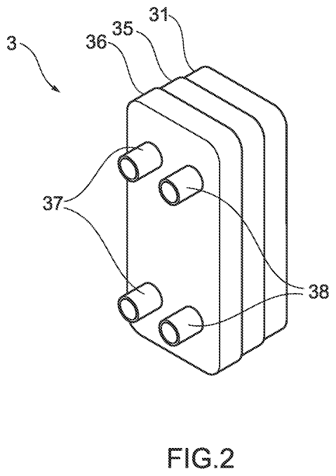

FIG. 2 is a schematic view illustrating a schematic configuration of the external device heat exchanger 3 provided for the heat management system 1. As shown in FIG. 2, the external device heat exchanger 3 is provided with a heat exchanger body 31, an electric heater 35, a heat insulation unit 36, a cooling liquid pipe 37 and a heat medium pipe 38.

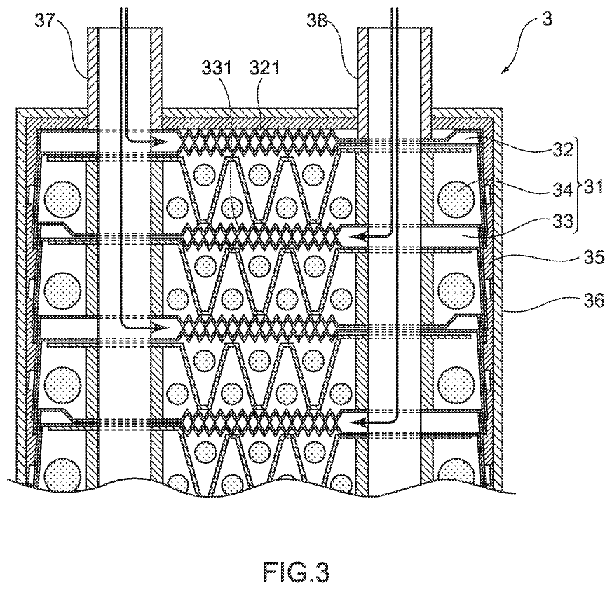

FIG. 3 is a cross-sectional view illustrating a schematic configuration of the external device heat exchanger 3 provided for the heat management system 1. As shown in FIG. 3, the heat exchanger body 31 is provided with a heat radiation unit 32 that radiates heat from the external device cooling system 4 using a cooling liquid from the external device cooling system 4 as a medium. Furthermore, the heat exchanger body 31 is provided with a heat reception unit 33 that causes the heat medium to receive the heat from the external device cooling system 4 radiated from the heat radiation unit 32, and a heat storage unit 34 provided between the heat radiation unit 32 and the heat reception unit 33.

The heat radiation unit 32 is made of a raw material having high thermal conductivity such as stainless steel (SUS316 or SUS304) or aluminum so as to efficiently radiate heat from the external device cooling system 4 using the cooling liquid from the external device cooling system 4. In order to exchange heat of the cooling liquid flown from the cooling liquid pipe 37 without leakage, the heat radiation unit 32 is provided with a flow path 321 for the cooling liquid to flow and hermetically sealed by a technique such as brazing as appropriate. One or a plurality of sets of heat radiation units 32 are provided for one external device heat exchanger 3.

In order to allow the heat medium to efficiently receive heat from the heat radiation unit 32 transmitted via the heat storage unit 34, the heat reception unit 33 is made of a raw material with high thermal conductivity such as stainless steel (SUS316 or SUS304) or aluminum, like the heat radiation unit 32. In order to exchange heat without leakage of the heat medium, the heat reception unit 33 is provided with a flow path 331 for the heat medium to flow like the heat radiation unit 32 and hermetically sealed by a technique such as brazing as appropriate. One or a plurality of sets of heat reception units 33 are provided for one external device heat exchanger 3.

Between one set of heat radiation unit 32 and heat reception unit 33, the heat storage unit 34 is provided so as to fill between the heat radiation unit 32 and the heat reception unit 33 with a heat storage material so as to receive heat from the heat radiation unit 32 and allow the heat reception unit 33 to receive the heat. The heat storage unit 34 secures a necessary contact area between the heat radiation unit 32 and the heat reception unit 33 so that heat can be transmitted efficiently between the heat radiation unit 32 and the heat reception unit 33. A vanadium dioxide (VO₂)-based heat storage material may be used for the heat storage unit 34. Note that a heat storage material other than the above vanadium dioxide-based heat storage material may also be used for the heat storage unit 34.

The electric heater 35 is provided so as to cover the heat radiation unit 32, the heat reception unit 33 and the heat storage unit 34. The electric heater 35 heats the heat storage unit 34 using power supplied from the outside, for example, during charging of a traveling battery. That is, the electric heater 35 functions as an electric heating unit. The heat storage unit 34 can store the heat added by the electric heater 35. The electric heater 35 may cover at least the heat storage unit 34 so as to heat the heat storage unit 34. The heat insulation unit 36 is provided between the electric heater 35 and the heat insulation unit 36. The heat insulation unit 36 covers the heat exchanger body 31 and the electric heater 35 from the outside. The cooling liquid pipe 37 is a pipeline connected to the cooling liquid circuit CL to circulate the cooling liquid between the external device cooling system 4 and the flow path 321 of the heat radiation unit 32. The heat medium pipe 38 is a pipeline connected to the heat medium circuit HM to circulate the heat medium between the component of the air conditioner in the heat management system 10 such as the external device heat exchanger 3 and the HVAC unit 60, and the flow path 331 of the heat reception unit 33.

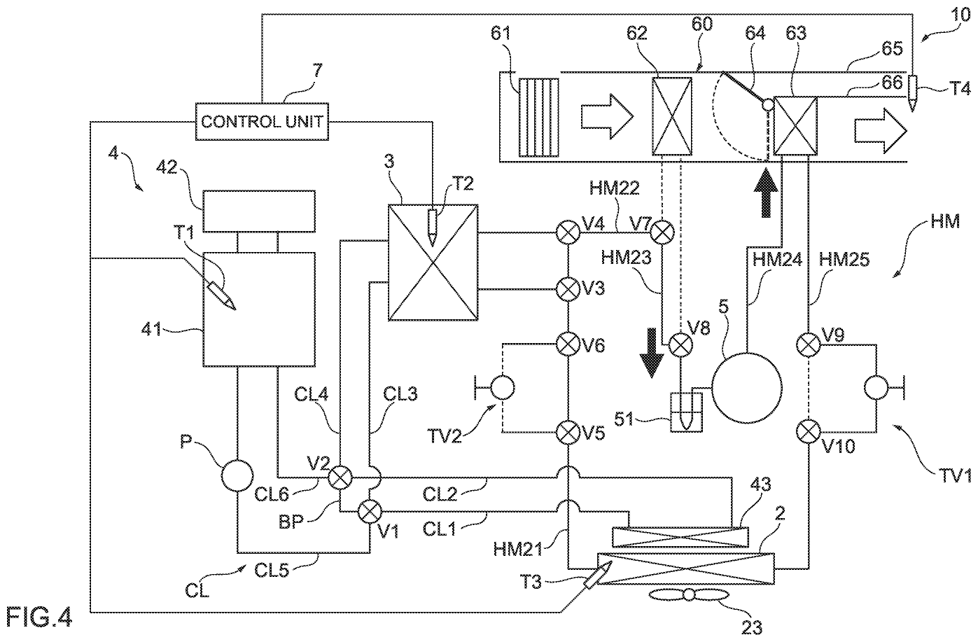

As shown in FIG. 4, the compressor 5 is provided after the external device heat exchanger 3 and before the indoor heat exchanger 6 in the flow path of the heat medium of the heat management system 1. The compressor 5 uses electric power as a power source. The compressor 5 compresses the heat medium that has passed through the external device heat exchanger 3.

The indoor heat exchanger 6 is provided after the compressor 5 and before the expansion valve TV in the flow of the heat medium circuit HM in the flow path of the heat medium of the heat management system 1. More specifically, the indoor heat exchanger 6 faces the interior of the room, which is the heat management target of the heat management system 1 and functions as a condenser that radiates heat stored in the heat medium to the indoor air.

The expansion valve TV is provided in the heat medium circuit HM 14 connecting the indoor heat exchanger 6 and the outdoor heat exchanger 2. The expansion valve TV decompresses and expands the heat medium that has passed through the indoor heat exchanger 6 to a state in which it can be easily evaporated and secures an optimum flow rate inside the evaporator.

Next, operation of the heat management system 1, the structure of which has been described so far will be described.

In the outdoor heat exchanger 2, a liquid heat medium deprives outdoor air of heat to thereby raise the temperature of the heat medium that passes through the outdoor heat exchanger 2. The heat medium that has passed through the outdoor heat exchanger 2 changes from liquid to gas.

The external device heat exchanger 3 receives waste heat from the external device 40 via the cooling liquid of the external device cooling system 4. The external device heat exchanger 3 causes the heat medium to receive the waste heat from the external device 40 to further raise the temperature of the heat medium. The external device heat exchanger 3 causes the heat storage unit 34 provided between the heat radiation unit 32 and the heat reception unit 33 to store the heat from the cooling liquid and then delivers the heat to the heat medium. That is, the external device heat exchanger 3 stores heat generated by the external device 40 and exchanges heat with the heat medium.

The compressor 5 compresses the heat medium, the temperature of which has been raised by the outdoor heat exchanger 2 and the external device heat exchanger 3, and further raises the temperature of the heat medium.

The indoor heat exchanger 6 causes the heat medium, the temperature of which has been raised by the compressor 5 to condense, radiates the heat stored by the heat medium to indoor air and raises the temperature of the indoor air. The heat medium radiated in the heat management system 10 is liquefied, expanded by the expansion valve TV and enters the outdoor heat exchanger 2. Using the above-described steps as one cycle, the heat management system 1 repeats this cycle.

The heat management system 1 configured as described above can receive heat from the cooling liquid of the external device cooling system 4 by providing the external device heat exchanger 3 between the compressor 5 and the indoor heat exchanger 6. According to the heat management system 10 configured as described above, the flow rate of the heat medium as a gas is increased by heating the heat medium flowing through the compressor 5 when the temperature is low. According to the heat management system 1 configured as described above, it is possible to receive heat from the external device 40 and raise the temperature of the heat medium. Therefore, according to the heat management system 1, even when the temperature of the heat medium cannot be increased depending on the outdoor heat exchanger 2, for example, when the outside air temperature is −10° C. or below, it is possible to raise the temperature of the vehicle room using the heat pump scheme with low energy consumption required to heat air.

According to the heat management system 1, since the heat storage unit 34 is provided between the heat radiation unit 32 and the heat reception unit 33 in the external device heat exchanger 3, it is possible to receive heat generated by the external device 40 via the heat radiation unit 32, store the heat for a predetermined time and use the heat to raise the temperature of the heat medium. Therefore, according to the heat management system 1, the heat storage unit 34 stores heat generated in the external device 40 such as a traveling motor, an inverter or a traveling battery during traveling of an electric vehicle, for example, and uses the heat to raise the temperature of the heat medium at startup. According to the heat management system 1, the heat storage unit 34 is provided with the external device cooling system 4, and can thereby raise the temperature of the heat medium faster immediately after the startup.

The heat management system 1 is provided with the external device heat exchanger 3 that operates as described above, and can thereby reduce the amount of work of the compressor 5 used to raise the temperature of the heat medium compared to a general heat pump type air conditioner. Therefore, according to the heat management system 1, it is possible to reduce energy consumption used for heat management.

### Second Embodiment

Next, a heat management system according to a second embodiment of the present invention will be described.

FIG. 4 is a functional block diagram illustrating a schematic configuration of a heat management system 10 according to a second embodiment of the present invention. The heat management system 10 in the second embodiment is the heat management system according to the present invention, a configuration of which will be described more specifically. The heat management system 10 in the present embodiment is a heat pump type air conditioner using air heat outside the room as a heat source as in the case of the heat management system 1 described above. The heat management system 10 is different from the above-described heat management system 1 in that it includes not only the heating function but also a cooling function, and adjusts the temperature inside the vehicle room to a desired temperature by raising or lowering the temperature in the vehicle room. Note that description of components in the present embodiment similar to the components in the above-described heat management system 1 will be omitted.

As shown in FIG. 4, the heat management system 10 is provided with the outdoor heat exchanger 2, the external device heat exchanger 3, the external device cooling system 4, the compressor 5, an HVAC (heating, ventilation, and air conditioning) unit 60, and a control unit 7 as main components. The configuration of the heat management system 10 will be described by dividing the configuration into a cooling liquid circuit that performs heat exchange by circulating a cooling liquid and a heat medium circuit that performs heat exchange by circulating a heat medium. Moreover, operation of the heat management system 10 when heat is exchanged between the cooling liquid and the heat medium will be described in the present embodiment.

The external device heat exchanger 3 and the external device cooling system 4 are connected to the cooling liquid circuit.

The external device cooling system 4 connected to the cooling liquid circuit CL is a system for cooling external devices such as a motor 41 for traveling of an electric vehicle, an inverter 42 for controlling the motor 41 or a traveling battery (not shown) as described above. The external device cooling system 4 is provided with a cooling heat exchanger 43 that radiates a cooling liquid such as LLC (long life coolant) of an external device such as the motor 41. The external device cooling system 4 is provided with flow paths CL1, CL2, CL5 and CL6 that form the cooling liquid circuit CL that can circulate a cooling liquid between the external device and the cooling heat exchanger 43 and a pump P provided in the flow path CL5 to send the cooling liquid from the cooling heat exchanger 43 to the external device.

A four-way valve V1 for controlling a flow path and a flow rate of a cooling liquid that flows into the external device, the external device heat exchanger 3 and the cooling heat exchanger 43 between the external devices such as the motor 41 and the inverter 42, the external device heat exchanger 3 and the cooling heat exchanger 43 is provided between the flow path CL1, a flow path CL3, and the flow path CL5 of the external device cooling system 4. A four-way valve V2 for controlling a flow path and a flow rate of a cooling liquid that flows out from the external device, the external device heat exchanger 3 and the cooling heat exchanger 43 is provided between the flow path CL2, a flow path CL4 and the flow path CL6 of the external device cooling system 4. A bypass BP, which is a flow path that connects the four-way valve V1 and the four-way valve V2 is provided between the four-way valve V1 and the four-way valve V2. The cooling liquid flow path CL in the external device cooling system 4 is provided with the four-way valve V1, the four-way valve V2 and the bypass BP, and can thereby form a path through which the cooling liquid circulates between the external devices such as the motor 41 and the inverter 42.

The outdoor heat exchanger 2, the compressor 5, an HVAC unit 60 and the external device heat exchanger 3 are connected to the heat medium circuit HM. The heat medium circuit HM is constructed of flow paths HM 22 to HM 25.

As described above, the outdoor heat exchanger 2 exchanges heat between the heat medium and outdoor air. The outdoor heat exchanger 2 functions as a condenser that radiates heat from the heat medium to the outdoor air and as an evaporator that absorbs heat from the outdoor air to the heat medium. A fan 23 that sends air to the outdoor heat exchanger 2 and the cooling heat exchanger 43 of the external device cooling system 4 is provided outside the outdoor heat exchanger 2.

As described above, the compressor 5 also compresses the heat medium, the temperature of which has been raised by the outdoor heat exchanger 2 and the external device heat exchanger 3 to further raise the temperature of the heat medium. A gas-liquid separator 51 may also be provided before the compressor 5. The gas-liquid separator 51 is provided so as to prevent the compressor 5 from compressing (liquid compressing) the liquid coolant, which has not been evaporated by the evaporator 62. The gas-liquid separator 51 separates the coolant flowing from the evaporator 62 into gas and liquid, and blows only the gas coolant to the compressor 5.

The HVAC unit 60 is provided with a blower 61, the evaporator 62, a condenser 63, an air path adjustment unit 64, a housing 65 and a duct 66.

The blower 61 blows air towards the evaporator 62 and condenser 63 in the housing 65. The evaporator 62 is connected to the outdoor heat exchanger 2 via a flow path HM 22 and connected to the compressor 5 via a flow path HM 23. A three-way valve V7 for controlling a flow rate of the heat medium to the evaporator 62 is provided in the flow path HM 22 between the evaporator 62 and the external device heat exchanger 3. A three-way valve V8 for controlling a flow rate of the heat medium to the evaporator 62 is provided in the flow path HM 23 between the evaporator 62 and the compressor 5.

The condenser 63 is connected to the compressor 5 via a flow path HM 24 and connected to the outdoor heat exchanger 2 via a flow path HM 25. The air path adjustment unit 64 adjusts an amount of air passing through the condenser 63. The housing 65 houses components of the HVAC unit 60. The duct 66 separates the air that has passed through the condenser 63 from the air that has not passed through the condenser 63 and sends the air to the vehicle room.

In the heat medium circuit HM, a heating expansion valve TV1 similar to the above-described expansion valve, that bypasses the heat medium circuit HM is provided between the condenser 63 of the HVAC unit 60 and the external device heat exchanger 3. The expansion valve TV1 is provided with three-way valves V9 and V10 that adjust the flow rate of the heat medium to the expansion valve TV1. In the heat medium circuit, a cooling expansion valve TV2 is provided between the outdoor heat exchanger 2 and a three-way valve V4 of the external device heat exchanger 3 so as to bypass the heat medium circuit HM. The expansion valve TV2 is provided with three-way valves V5 and V6 that adjust the flow rate of the heat medium of the expansion valve TV2.

As described above, the external device heat exchanger 3 receives the heat generated in the external device cooling system 4 via the cooling liquid and exchanges heat with the heat medium. In order for the external device heat exchanger 3 to receive heat from the cooling liquid of the external device cooling system 4, the flow path CL4 is connected to the four-way valve V2 between the flow path CL2 and the flow path CL6 of the external device cooling system 4. In the external device heat exchanger 3, in order to return the cooling liquid to the external device cooling system 4, the flow path CL3 is connected to the four-way valve V1 between the flow path CL1 and the flow path CL5 of the external device cooling system 4. By being connected to the four-way valves V1 and V2, the external device heat exchanger 3 can take in the cooling liquid from the cooling liquid circuit CL. The external device heat exchanger 3 is connected to the three-way valves V3 and V4 provided for the heat medium circuit HM directed from the outdoor heat exchanger 2 to the HVAC unit 60 so as to cause the heat medium to receive the heat received from the external device cooling system 4. By being connected to the three-way valves V3 and V4, the external device heat exchanger 3 can take in the heat medium of the heat medium circuit HM. The external device heat exchanger 3 is provided with the heat exchanger body 31 including the heat radiation unit 32 through which the cooling liquid flows, the heat reception unit 33 through which the heat medium flows, the heat storage unit 34 provided between the heat radiation unit 32 and the heat reception unit 33, the electric heater 35 and the heat insulation unit 36. In the heat management system 1 with the above configuration, the heat storage unit 34 stores heat from the heat radiation unit 32 and causes the heat reception unit 33 to receive the heat.

A thermometer T1 that measures a cooling liquid temperature of the motor 41, a thermometer T2 that measures a temperature of the heat storage unit 34 of the external device heat exchanger 3, a thermometer T3 that measures a cooling liquid temperature of the outdoor heat exchanger 2, and a thermometer T4 that measures a temperature in the vehicle room of the electric vehicle are connected to the control unit 7. The control unit 7 compares the measured temperatures of the thermometers T1 to T4 with respective thresholds (set temperatures) of the cooling liquid temperature of the motor 41, the temperature of the heat storage unit 34 of the external device heat exchanger 3, the cooling liquid temperature of the outdoor heat exchanger 2 and the temperature in the vehicle room, and thereby controls operation of the heat management system 1. More specifically, the control unit 7 compares the measured temperatures of the thermometers T1 to T3 with the respective thresholds (set temperature) of the cooling liquid temperatures of the motor 41, the external device heat exchanger 3 and the outdoor heat exchanger 2 and the temperature in the vehicle room, and performs opening/closing control of the four-way valves V1 and V2, and three-way valves V3 to V10 including the four-way valve V1 and four-way valve V2 of the cooling liquid of the external device heat exchanger 3 and the three-way valve V3 and three-way valve V4 of the heat medium. The opening/closing control of the four-way valves V1 and V2, and the three-way valves V3 to V10 in the heat management system 1 will be described later. The control unit 7 also performs powering-on and powering-off control during charging, which will be described later, on the heat storage unit 34 provided for the external device heat exchanger 3. Note that the control unit 7 may also perform various types of control relating to the heat management system 10 such as operation control of the HVAC unit 60 and operation control of the compressor 5.

### Operation of Heat Management System

Next, operation of the heat management system 10 described so far will be described.

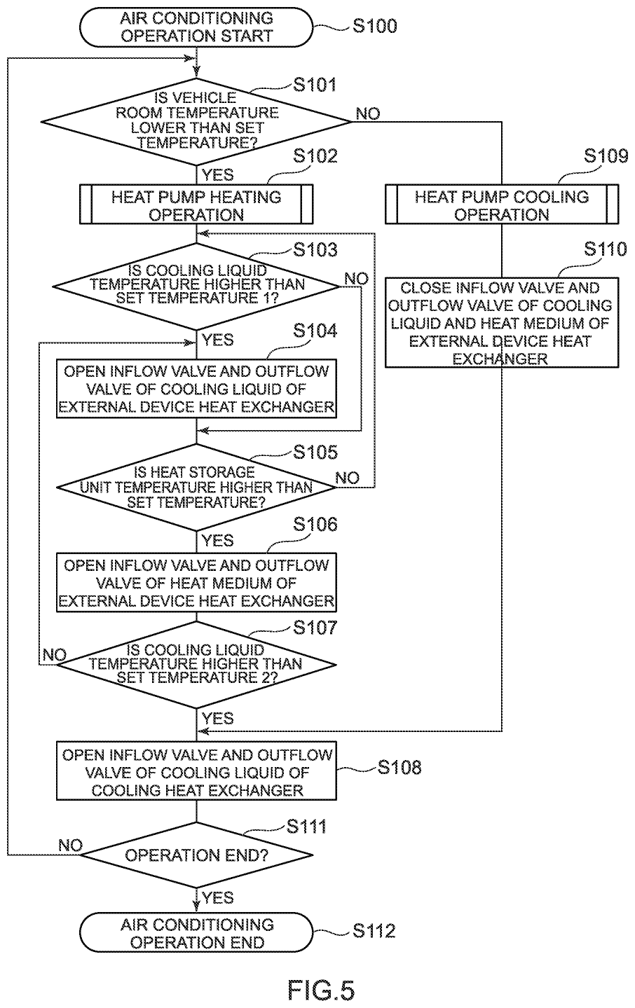

FIG. 5 is a flowchart illustrating operation of the heat management system according to the second embodiment. Hereinafter, operation of the control unit 7 during operation of the heat management system 10 will be described with reference to FIG. 4 and FIG. 5.

When power is supplied to the electric vehicle on which the heat management system 10 is mounted or power of this system is supplied, the system starts air conditioning operation (S100).

The control unit 7 compares the measured temperature of the thermometer T4 in the vehicle room with the set temperature in the vehicle room and determines whether the measured temperature of the thermometer T4 is lower than the set temperature or not (S101). When the measured temperature of the thermometer T4 is lower than the set temperature (S101: YES), the control unit 7 executes heat pump type heating operation by the heat management system 10 (S102). Here, the set temperature to be compared with the measured temperature of the thermometer T4 used for the determination in S101 is a temperature to be criteria to determine whether heating operation is necessary or not (e.g., 20° C.).

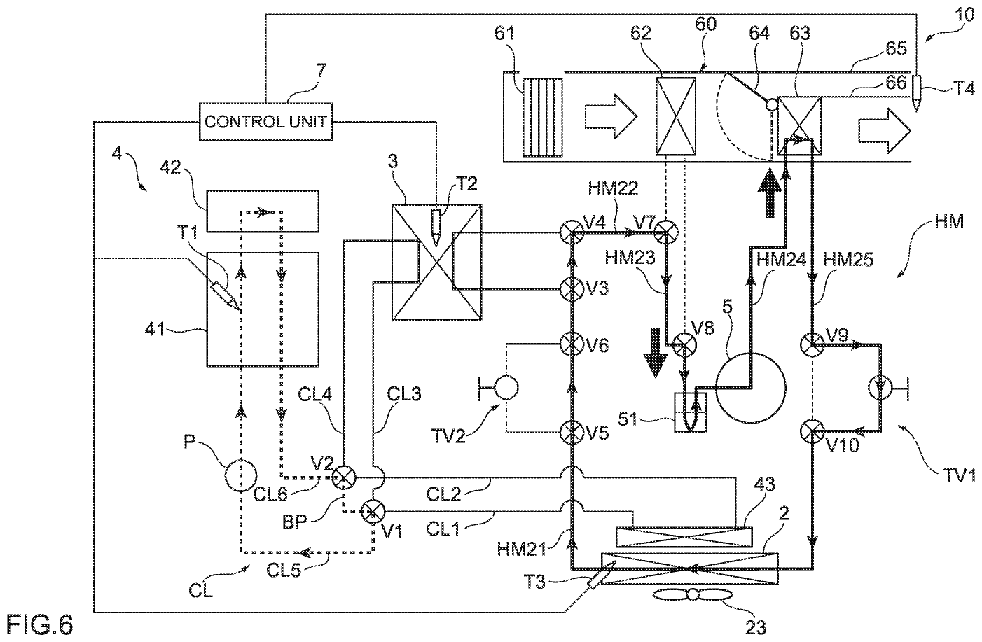

FIG. 6 is a functional block diagram illustrating operation immediately after heating operation starts in the heat management system 10 according to the second embodiment. When it is determined that the heating operation has started, the control unit 7 controls the four-way valves V1 and V2, and the three-way valves V3 to V10 so that the heat of the cooling liquid circuit CL circulates through the heat medium circuit HM. The control unit 7 controls open/closed states of the three-way valves V3 to V10 in such a way that the heat medium that flows out from the outdoor heat exchanger 2 passes through the gas-liquid separator 51, the compressor 5, the condenser 63 and the heating expansion valve TV1, but the heat medium does not pass through the cooling expansion valve TV2, the external device heat exchanger 3 and the evaporator 62. That is, immediately after the heating operation starts, the heat medium circuit HM forms a circulation path as shown by thick solid lines and arrows in FIG. 6 from the outdoor heat exchanger 2 to the flow path HM 21, the flow path HM 22, the flow path HM 23, the gas-liquid separator 51, the compressor 5, the flow path HM 24, the condenser 63, the flow path HM 25, and the heating expansion valve TV1 in order. Immediately after the heating operation starts, the cooling liquid circuit CL forms a circulation path as shown by broken lines and arrows in FIG. 6 from the flow path CL5 to the pump P, the motor 41 and the inverter 42, and the flow path CL6 in order.

The control unit 7 compares the measured temperature of the thermometer T1 of the cooling liquid of the motor 41 with the set temperature of the cooling liquid of the motor 41, and determines whether the measured temperature of the thermometer T1 is higher than the first set temperature (set temperature 1) or not (S103). Here, the first set temperature of the cooling liquid is a temperature of the cooling liquid, which becomes a threshold to determine whether to allow the cooling liquid of the external device cooling system 4 to flow into the external device heat exchanger 3 or not. When the measured temperature of the thermometer T1 is higher than the set temperature 1 (S103: YES), the control unit 7 operates the four-way valve V1 and the four-way valve V2 of the heat management system 10 and allows the cooling liquid to flow into/out from the external device heat exchanger 3 (S104).

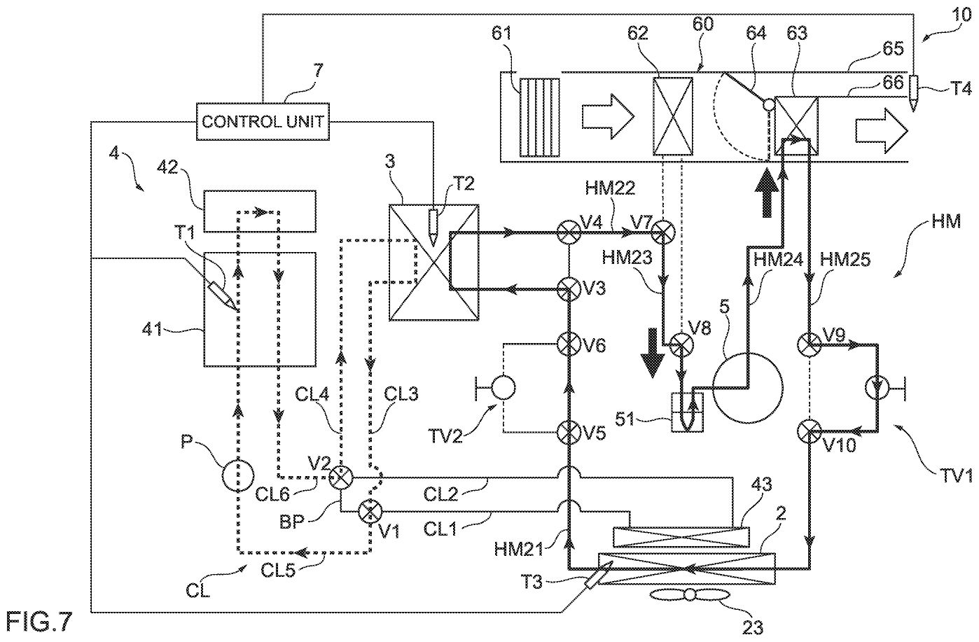

On the other hand, when the measured temperature of the thermometer T1 is lower than the set temperature 1 (S103: NO), the control unit 7 compares the measured temperature of the thermometer T2 that measures the temperature of the heat storage unit 34 of the external device heat exchanger 3 with the set temperature of the heat storage unit 34 and determines whether the measured temperature of the thermometer T2 is higher than the set temperature (S105) or not. Here, the set temperature of the heat storage unit 34 is a temperature, which becomes a threshold to determine whether to allow the heat medium to flow into the external device heat exchanger 3 or not. When the measured temperature of the thermometer T2 is higher than the set temperature (S105: YES), the control unit 7 operates the three-way valve V3 and the three-way valve V4 of the heat management system 10 and allows the heat medium to flow into/out from the external device heat exchanger 3 (S106). FIG. 7 is a functional block diagram illustrating operation of heat exchange by the external device heat exchanger 3 in the heat management system 10 according to the second embodiment. That is, when the heat management system 10 performs the process in S106, the external device heat exchanger 3 can exchange heat between the cooling liquid and the heat medium. Here, the heat medium circuit HM forms a circulation path as shown by thick solid lines and arrows in FIG. 7 from the outdoor heat exchanger 2 to the flow path HM 21, the external device heat exchanger 3, the flow path HM 22, the flow path HM 23, the gas-liquid separator 51, the compressor 5, the flow path HM 24, the condenser 63, the flow path HM 25 and the heating expansion valve TV1 in order. The cooling liquid circuit CL forms a circulation path as shown by broken lines and arrows in FIG. 7 from the external device heat exchanger 3, the flow path CL3, the flow path CLS, the pump P, the motor 41 and the inverter 42, the flow path CL6, and the flow path CL4 in order. On the other hand, when the measured temperature of the thermometer T2 is lower than the set temperature (S105: NO), the control unit 7 returns to the determination process in S103.

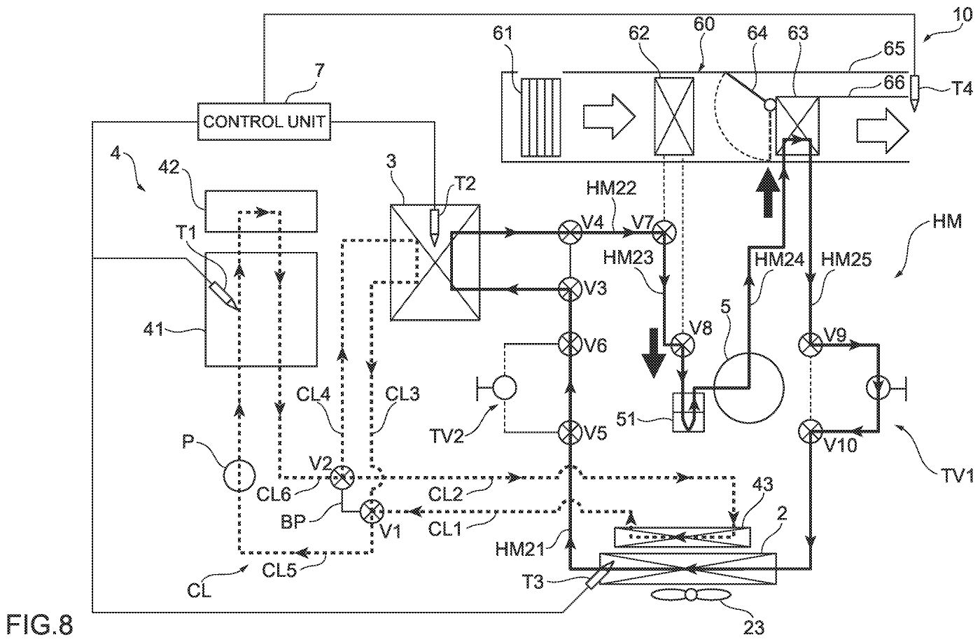

The control unit 7 compares the measured temperature of the thermometer T1 of the cooling liquid of the motor 41 with the set temperature of the cooling liquid of the motor 41 and determines whether the measured temperature of the thermometer T1 is higher than a second set temperature (set temperature 2) or not (S107). Here, the second set temperature of the cooling liquid is a temperature of the cooling liquid, which becomes a threshold to determine whether to allow the cooling liquid of the external device cooling system 4 to flow into the cooling heat exchanger 43 and to be radiated or not. When the measured temperature of the thermometer T1 is higher than the set temperature 2 (S107: YES), the control unit 7 operates the four-way valve V1 and the four-way valve V2 of the heat management system 10 so as to allow the cooling liquid to flow into/out from the cooling heat exchanger 43 in addition to the external device heat exchanger 3 (S108). FIG. 8 is a functional block diagram illustrating operation of heat exchange by the external device heat exchanger 3 and the cooling heat exchanger 43 in the heat management system 10 according to the second embodiment. When the heat management system 10 performs the process in S108, the external device heat exchanger 3 exchanges heat between the cooling liquid and the heat medium, and the cooling heat exchanger 43 exchanges heat between the cooling liquid and outside air. Cooling liquids from the flow path CL3 from the external device heat exchanger 3 and the flow path CL1 from the cooling heat exchanger 43 flow into the flow path CL5 that causes the cooling liquid to flow into the external device in the cooling liquid circuit CL as shown by broken lines and arrows in FIG. 8. In the cooling liquid circuit CL, cooling liquids are flown into the flow path CL4 toward the external device heat exchanger 3 and the flow path CL2 toward the cooling heat exchanger 43 from the flow path CL6 that causes the cooling liquid from the external device to flow out. Note that the heat medium circuit HM like FIG. 7, forms a circulation path from the outdoor heat exchanger 2, to the flow path HM 21, the external device heat exchanger 3, the flow path HM 22, the flow path HM 23, the gas-liquid separator 51, the compressor 5, the flow path HM 24, the condenser 63, the flow path HM 25, and the heating expansion valve TV1 in order.

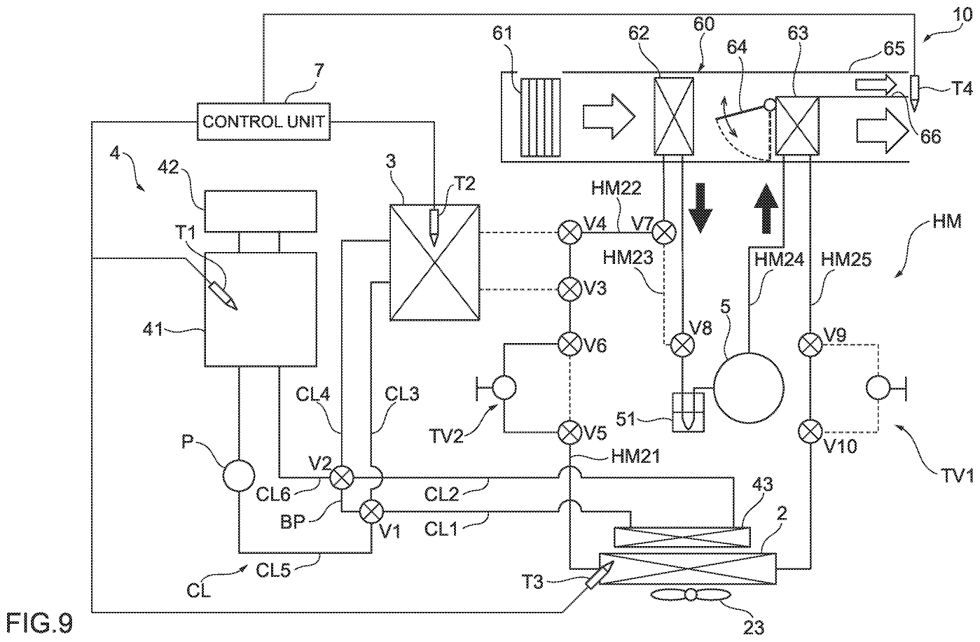

FIG. 9 is a functional block diagram illustrating operation during cooling operation in the heat management system according to the second embodiment. When the measured temperature of the thermometer T4 is higher than the set temperature (S101: NO), the control unit 7 executes the heat pump type cooling operation by the heat management system 10 (S109). When it is determined that the cooling operation has started, the control unit 7 controls open/closed states of the three-way valves V3 to V10 provided for the heat medium circuit HM of the heat management system 10 in such a way that the cooling liquid flowing out from the outdoor heat exchanger 2 passes through the gas-liquid separator 51, the compressor 5, the evaporator 62 and the condenser 63. When it is determined that the cooling operation has started, the control unit 7 controls the open/closed states of the three-way valves V3 to V10 in such a way that the cooling liquid does not pass through the heating expansion valve TV1, the external device heat exchanger 3 and the evaporator 62 (S110). That is, during cooling operation, the heat medium circuit HM forms a circulation path from the outdoor heat exchanger 2, to the flow path HM 21, the cooling expansion valve TV2, the flow path HM 22, the evaporator 62, the gas-liquid separator 51, the compressor 5, the flow path HM 24, the condenser 63 and the flow path HM 25 in order. After the process in S110, the control unit 7 proceeds to the process in S108, and causes the cooling liquid to flow into or flow out from the cooling heat exchanger 43. That is, during cooling operation, the cooling liquid circuit CL forms a circulation path from the cooling heat exchanger 43 to the flow path CL1, the flow path CL5, the pump P, the external device, the flow path CL6, and the flow path CL2 in order. When the heat management system 10 performs cooling operation, the cooling operation operates in the reverse cycle of the aforementioned heating operation. That is, during the cooling operation of the heat management system 10, the evaporator 62 receives heat in the room, the outdoor heat exchanger 2 functions as a condenser and radiates heat in the room to the outside of the room.

The control unit 7 checks if the air conditioning operation has ended or not (S111). The control unit 7 repeats the aforementioned processes in S101 to S110 until the air conditioning operation ends (S111: NO). On the other hand, when the air conditioning operation has ended (S111: YES), the control unit 7 ends the aforementioned processes. Note that during dehumidification heating operation, the heat management system 10 cools outside air using the evaporator 62, thereby condenses and removes vapor contained in the outside air, heats the air from which vapor has been removed using the condenser 63 and sends the outside air into the room. In this case, the control unit 7 of the heat management system 10 determines whether or not to raise the temperature of the heat medium flowing through the heat medium circuit HM by the external device heat exchanger 3 in accordance with the indoor temperature.

As described above, according to the heat management system 10 of the present embodiment, the heat management system 10 is provided with the control unit 7 that controls the cooling liquid and the heat medium flowing through the external device heat exchanger 3. For this reason, according to the heat management system 10 of the present embodiment, it is possible to reduce energy consumption and improve heating performance by appropriately controlling operation of the external device heat exchanger 3 in accordance with room temperature, cooling liquid temperature and heat medium temperature.

### Operation During Charging

Next, in the case where the above-described heat management system 10 is mounted on an electric vehicle, operation of the heat management system 10 when charging a traveling battery (storage battery) of the electric vehicle will be described.

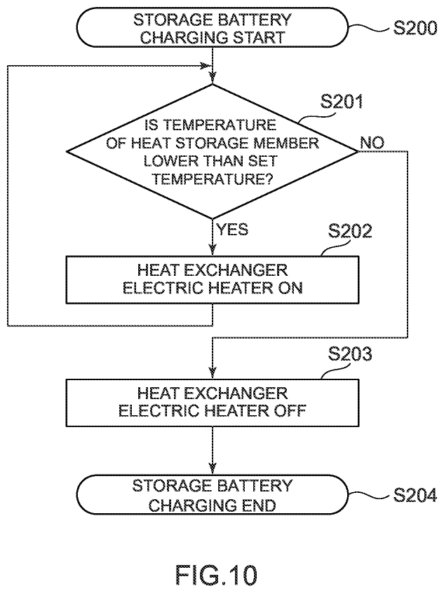

FIG. 10 is a flowchart illustrating operation during charging of the storage battery in the heat management system according to the second embodiment. As shown in FIG. 10, when charging of the storage battery starts (S200), the control unit 7 compares the measured temperature of the thermometer T2 that measures a temperature of the heat storage unit 34 with a set temperature of the heat storage unit 34 and determines whether the measured temperature of the thermometer T2 is higher than the set temperature or not (S201).

When the measured temperature of the thermometer T2 is lower than the set temperature (S201: YES), the control unit 7 determines that the heat generated by the electric heater 35 can be stored in the heat storage unit 34 and turns on a power switch of the electric heater 35 (S202). After turning on the power of the electric heater 35, the control unit 7 repeats the process in S201 and continues determining whether the heat can be stored in the heat storage unit 34 or not.

On the other hand, when the measured temperature of the thermometer T2 is higher than the set temperature (S201: NO), the control unit 7 determines that the heat generated by the electric heater 35 cannot be stored in the heat storage unit 34 and turns off the power switch of the electric heater 35 (S203). After turning off the power switch of the electric heater 35, the control unit 7 ends the process when charging of the storage battery ends (S204).

As described so far, according to the heat management system 10 of the present embodiment, the heat management system 10 is provided with the electric heater 35 that can heat the heat storage unit 34 of the external device cooling system 4. As a result, the heat management system 10 can receive energy from the outside during charging or the like of the traveling battery in the electric vehicle and store thermal energy. That is, the heat management system 10 quickly obtains thermal energy immediately after the system is started, and can thereby improve heating performance.

### Third Embodiment

Next, a heat management system according to a third embodiment of the present invention will be described.

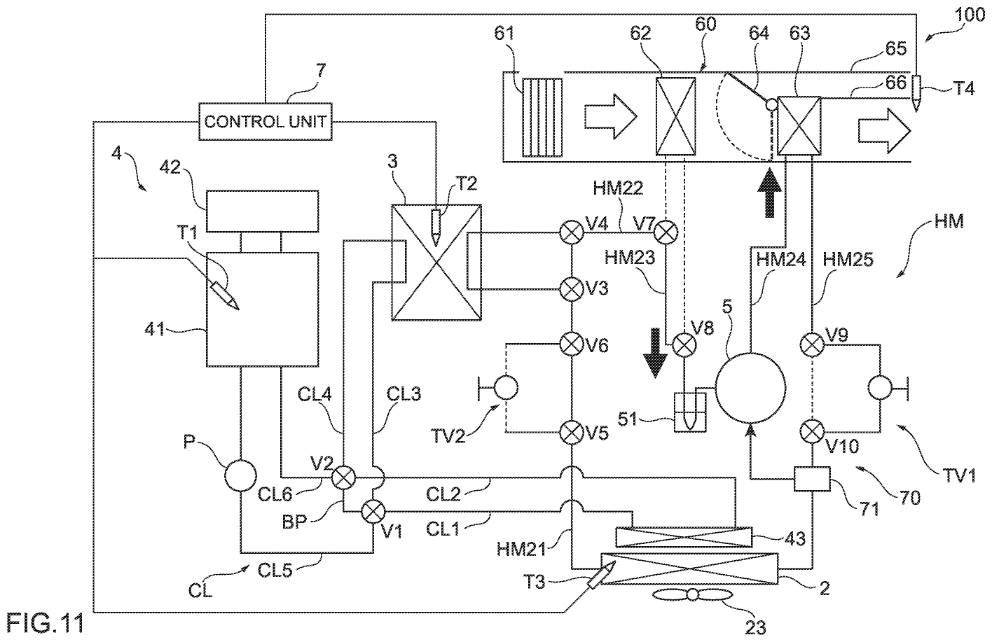

FIG. 11 is a functional block diagram illustrating a schematic configuration of a heat management system according to a third embodiment of the present invention. In the third embodiment, a heat management system 100 describes the configuration of another embodiment of the heat management system according to the present invention. The heat management system 100 of the present embodiment is different from the aforementioned heat management system 10 in that it is provided with an injection circuit 70.

Note that components of the heat management system 100 according to the present embodiment other than the aforementioned injection circuit 70 and peripheral components are similar to the components of the heat management systems 1 and 10, and so description will be omitted.

The injection circuit 70 is provided between an inflow three-way valve V10 of the heating expansion valve TV1 and an inflow port of the outdoor heat exchanger 2. The injection circuit 70 is provided with a cooling liquid gas-liquid separator 71. The gas-liquid separator 71 separates a heat medium flown in from the condenser 63 via the heating expansion valve TV1 into gas and liquid. The injection circuit 70 sends a gas component of the heat medium separated by the gas-liquid separator 71 into the compressor 5. The gas component of the heat medium sent into the compressor 5 is compressed again and condensed by the condenser 63. On the other hand, the injection circuit 70 sends a liquid component of the heat medium separated by the gas-liquid separator 71 into the outdoor heat exchanger 2. The liquid component of the heat medium sent into the outdoor heat exchanger 2 is heat-exchanged with outdoor air.

The injection circuit 70 of the heat management system 100 separates only the gas component from the gas-liquid mixed heat medium compressed by the compressor 5, returns the gas component to the compressor 5 and compresses the gas component. In this way, the heat management system 100 increases the flow rate of the heat medium and improves efficiency in heat exchange between the heat medium and air. In the heat management system 100, only the liquid is flown into the condenser 63 by the injection circuit 70, and so efficiency in heat exchange with the atmosphere can also be improved. According to the heat management system 100, it is possible to improve efficiency and expand the lower limit temperature that enables heating capability to be secured compared to the heat management system 10 or the like.

Like the heat management systems 1 and 10, the heat management system 100 can raise the indoor temperature in short time even when there is a little or no difference between the outside air temperature and the heat medium temperature in an environment in which the outside air temperature falls below a minimum temperature of the heat medium, for example, in an extremely cold region.

As described above, since the heat management system 100 is provided with the external device heat exchanger 3, it is possible to reduce energy consumption and improve heating performance.

Although the embodiments of the present invention have been described so far, the present invention is not limited to the heat management systems according to the embodiments of the present invention, but includes all aspects included in the concept and claims of the present invention. The respective components may be selectively combined as appropriate so that at least some of the aforementioned problems or effects may be solved or exerted. For example, shapes, materials, arrangements, sizes or the like of the respective components of the above embodiments can be changed as appropriate according to specific usage of the present invention.

Although cases have been described in the embodiments described so far where all the heat management systems are applied as air conditioners of electric vehicles, the present invention is not limited to this. The present invention is useful as an air conditioner used for vehicles not including an internal combustion engine available as a heat source during heating such as fuel cell powered vehicles or vehicles for which an internal combustion engine is not always in operation such as hybrid vehicles or plug-in hybrid vehicles in addition to electric vehicles. The present invention is also available as an air conditioner for vehicles including an internal combustion engine. Furthermore, the present invention is also available as an air conditioner for vehicles other than automobiles such as trains.

Although cases have been described in the embodiments described so far where all the heat management systems are applied as air conditioners for vehicles, the present invention is not limited to this. The present invention can be used as an air conditioner for moving bodies other than vehicles such as ships or for buildings. In this case, heating of the heat storage unit 34 by the electric heater 35 can be performed all the time as long as power is supplied to the heat management system.

Furthermore, although cases have been described in the embodiments described so far where all the heat management systems are applied as air conditioners, the present invention is not limited to this. The present invention can also be used as a heating apparatus for various types of equipment.

### LIST OF REFERENCE SIGNS

1 heat management system,

2 outdoor heat exchanger,

3 external device heat exchanger,

4 external device cooling system,

5 compressor,

6 indoor heat exchanger,

7 control unit,

10 heat management system,

23 fan,

31 heat exchanger body,

32 heat radiation unit,

33 heat reception unit,

34 heat storage unit,

35 electric heater,

36 heat insulation unit,

37 cooling liquid pipe,

38 heat medium pipe,

40 external device,

41 motor,

42 inverter,

43 cooling heat exchanger,

51 gas-liquid separator,

60 HVAC unit,

61 blower,

62 evaporator,

63 condenser,

64 air path adjustment unit,

65 housing,

66 duct,

70 injection circuit,

71 gas-liquid separator

1. A heat management system that performs heat management in a room, comprising:
an outdoor heat exchanger that exchanges heat between a heat medium and outdoor air;
a compressor that compresses the heat medium heat-exchanged by the outdoor heat exchanger;
an indoor heat exchanger that exchanges heat between the heat medium compressed by the compressor and the indoor air; and
an external device heat exchanger provided between the outdoor heat exchanger and the compressor, that exchanges heat between the heat generated by the external device and the heat medium.

2. The heat management system according to claim 1, wherein
the outdoor heat exchanger receives heat from the outdoor air and radiates the heat to the heat medium,
the external device heat exchanger receives heat from the external device and radiates the heat to the heat medium,
the compressor compresses and heats the heat medium, the heat of which is received from the outdoor heat exchanger and the external device heat exchanger, and
the indoor heat exchanger heats the indoor air with the heat medium heated by the compressor.

3. The heat management system according to claim 1, wherein the external device heat exchanger stores heat generated by the external device and exchanges heat with the heat medium.

4. The heat management system according to claim 3, wherein
the external device heat exchanger comprises:
a heat radiation unit that radiates heat generated by the external device;
a heat storage unit that stores heat radiated by the heat radiation unit; and
a heat reception unit that causes the heat medium to receive the heat stored in the heat storage unit.

5. The heat management system according to claim 4, wherein the external device heat exchanger comprises an electric heating unit that heats the heat storage unit.
